(19) United States
(12) Patent Application Publication
(10) Pub. No.: US 2026/0146142 A1
(43) Pub. Date: May 28, 2026

(54) WAVELENGTH DOWNCONVERTERS

(71) Applicants: LAMBDA ENERGY LTD, Cranfield Bedfordshire (GB); THE UNIVERSITY OF BATH, Bath (GB); CAMBRIDGE ENTERPRISE LIMITED, Cambridge, Cambridgeshire (GB)

(72) Inventors: Rosa Marie MÜLLER, Cambridge (GB); Prof. Dominic Simon WRIGHT, Cambridge (GB); Dr. Bibian Odion OKOKHERE-EDEGHOGHON, Bath (GB); Prof. Petra Jane Cameron, Bath (GB); Dr. Robert William Baker, Bath (GB); Dr. Monica Sabrina SAAVEDRA, Cranfield (GB); Dr. Aleksandar Asenov ILCHEV, Cranfield (GB); Mark Edward BRENCHLEY, Cranfield (GB); Dr. Boris BREINER, Cranfield (GB); Dr. Andreas Michael WAEBER, Cranfield (GB); Dr. Norbert Jaroslaw JANOWICZ, Cranfield (GB)

(21) Appl. No.: 19/166,933

(22) PCT Filed: Mar. 22, 2024
(86) PCT No.: PCT/GB2024/050778

§ 371 Date: Sep. 19, 2025

(30) Foreign Application Priority Data
Mar. 22, 2023 (GB) 2304166.8

(51) Int. Cl. C08K 5/00; C08F 20/14; C09D 7/62; C09D 133/12

(52) U.S. Cl. CPC C08K 5/0091; C08F 20/14; C09D 7/62; C09D 133/12

(57) ABSTRACT

Methods of manufacturing polyoxotitanates, polymer-polyoxotitanate composite materials and novel polyoxotitanates are provided. The invention enables spectral conversion of sunlight towards longer wavelengths, which is beneficial for increasing 5 available photons for photosynthesis.

### FIELD OF INVENTION

The invention relates to compounds that convert electromagnetic radiation to a longer wavelength, methods of their manufacture and their commercial implementation.

### BACKGROUND

Many biological and synthetic processes utilise solar radiation as their energy source. Although most electromagnetic radiation received from the Sun falls within the wavelength range of 100 nm to 1 mm (i.e. ultraviolet to infrared), some processes use only a narrow bandwidth. Therefore, a significant amount of incident solar radiation is wasted. For such processes it is desirable to convert the non-utilised bandwidth to a wavelength range that can be utilized, thereby improving the process efficiency. For example, a photosynthesizing plant uses longer wavelengths, so downconverting the UV end of the spectrum would increase the energy available for photosynthesis. Photovoltaic cells also use a much narrower bandwidth of electromagnetic radiation than is incident from the Sun and could therefore be made more productive if the incident light were to be converted to the optimum wavelength for the semiconductor bandgap.

Numerous improvements are desirable for existing spectral conversion materials. Synthesis routes are typically complex and costly, for example, manufacturing monodisperse quantum dots.

### SUMMARY

The invention provides novel polyoxotitanates (POTs). These polyoxotitanates comprise a metal oxide core and a ligand shell. The metal oxide core comprises titanium, oxygen and a lanthanide. The lanthanide may be selected from europium (Eu), samarium (Sm), erbium (Er), terbium (Tb) and ytterbium (Yb), preferably selected from europium, samarium, erbium, terbium (Tb), most preferably europium. The ligand shell may also comprise one or more light-harvesting ligands (also known as antenna ligands) coordinated to the lanthanide. The one or more light-harvesting ligands comprises one or more of the following classes of compounds: 2-quinolines with a substituent in the 8-position; quinones; substituted 2,2′-bipyridines; substituted 1,10-phenanthrolines; naphthyridine; anthraquinones; catechols; acetylacetonates (acac); and substituted 2,2′;6′,2″-terpyridine. The one or more light-harvesting ligands are coordinated to the lanthanide (or lanthanides). Preferably the one or more light-harvesting ligands are coordinated only to the lanthanide(s); this is believed to improve the efficiency of energy transfer between the photon-excited ligand and the lanthanide.

Where a ligand is substituted, suitable substituents may be selected from H, F, isopropyl, C₁₋₃₀ linear alkyl or alkoxy, C₁₋₃₀ branched alkyl or alkoxy, and aryl, with the proviso that at least one substituted position is not H.

Preferably, the one or more light-harvesting ligands comprises one or more of the following classes of compounds: 2-quinolines with a substituent in the 8-position; quinones; substituted 2,2′-bipyridines; substituted 1,10-phenanthrolines; naphthyridine; anthraquinones; catechols; and acetylacetonates (acac).

In some embodiments, the one or more light-harvesting ligands are selected from 1-10 phenanthrolines and acetylacetonates.

In some embodiments, the light-harvesting ligand is a bidentate or tridentate chelating ligand.

In some embodiments, the light-harvesting ligand binds to the lanthanide via N, O, or both N and O. N- or O-bonding will be strong with a lanthanide (hard-hard interaction). In contrast, bonding between the lanthanide and, for example, S— or P— from a ligand would be much weaker.

In some embodiments, the POTs comprise one or more bridging ligands. A bridging ligand may be bound to either Ti or to a Ti and a lanthanide. Preferably a bridging ligand is bound to (coordinated to) a Ti and a Ln of the metal oxide core.

The bridging ligand may be bound to Ti, or to Ti and a lanthanide, by a functional group. The functional group may be selected from carboxylate, acetylacetonate (acac), alcoholate, and combinations thereof.

The bridging ligand may comprise one or more side chains which function to increase compatibility of the POT to a surrounding material (for example, when a POT is solubilized in a polymer resin). The one or more side chains may be selected from alkyl chains and poly(akylene glycol) chains, such as alkyl chains and poly(ethylene glycol) chains, and may comprise a functional group selected from hydrogen, hydroxyl, alkene and alkyne.

In some embodiments, the novel polyoxotitanate may have a Eu₂Ti₄ core structure, with 4,7-dimethoxy-1, 10-phenanthroline as the light harvesting ligands, and octanoate as the bridging ligands.

In another aspect, the invention also provides novel polyoxotitanates comprising a metal oxide core and a ligand shell. The metal oxide core comprises titanium, oxygen and a lanthanide. The lanthanide may be selected from europium (Eu), samarium (Sm), erbium (Er), terbium (Tb) and ytterbium (Yb), preferably selected from europium, samarium, erbium, terbium (Tb), most preferably europium. The ligand shell may also comprise one or more light-harvesting ligands (also known as antenna ligands) coordinated to the lanthanide. The one or more light-harvesting ligands is selected from substituted extended aromatic ligands and benzoate ligands.

The one or more light-harvesting ligands may be one or both of a benzoate-based ligand and a phenanthroline-based ligand, according to the following structures:

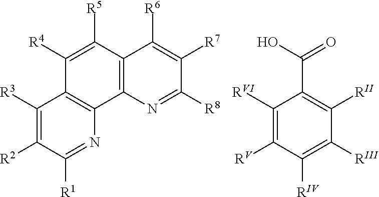

In the phenanthroline structure, R¹, R², R³, R⁴, R⁵, R⁶, R⁷ and R⁸ are each independently selected from H, C₁₋₃₀ linear alkyl or alkoxy and C₁₋₃₀ branched alkyl or alkoxy, with the proviso that at least one of R¹, R², R³, R⁴, R⁵, R⁶, R⁷ and R⁸ is not H. In the benzoate structure, R^{II}, R^{III}, R^{IV}, R^{V} and R^{VI} are each independently selected from H, F, isopropyl, linear or branched C₁₋₃₀ alkoxy, and linear or branched C₅₋₃₀ alkyl.

In some embodiments, at least one of R¹, R², R³, R⁴, R⁵, R⁶, R⁷ and R⁸ may be selected from C₁₂₋₁₈ linear alkyl, C₁₂₋₁₈ branched alkyl, C₁₂₋₁₈ linear alkoxy, C₁₂₋₁₈ branched alkoxy. In some embodiments, at least one of R^{II}, R^{III}, R^{IV}, R^{V} and R^{VI} may be selected from C₁₂₋₁₈ linear alkyl, C₁₂₋₁₈ branched alkyl, C₁₂₋₁₈ linear alkoxy, C₁₂₋₁₈ branched alkoxy. These longer alkyl and alkoxy chains help to solubilize the POTs in a polymer matrix.

The one or more light harvesting ligands may comprise any functionalized carboxylate, nitrogen-based polyaromatic, or dye-like ligand molecule, in particular polyaromatic ligands such as phenanthroline. For example, the one or more light harvesting ligands may comprise a ligand selected from 4-methoxybenzoic acid, 4-isopropylbenzoic acid, benzoic acid, and 4,7-dimethoxy-1,10-phenanthroline. POTs having 4-methoxybenzoic acid ligands were found to exhibit improved solubility in a polymer matrix and to have a red-shifted absorption. POTs having 4-isopropylbenzoic acid ligands were found to exhibit improved solubility in a polymer matrix and a good PLQY. POTs having 4,7-dimethoxy-1,10-phenanthroline ligands were found to exhibit better solubility, further red-shifted absorption and improved PLQY, relative to related compounds which do not have electron-donating organic groups within their frameworks.

The novel POTs may comprise one or more co-ligands in addition to the light-harvesting ligands. Herein these co-ligands are also referred to as “solubilizing ligands”, because they function to increase the solubility of the POTs in a polymer matrix. The solubilizing ligands are separate ligands and are preferably coordinated to Ti or O in the core, rather than to Eu. A suitable solubilizing ligand is methacrylate, which is especially useful when using a PMMA matrix.

In some embodiments, the metal oxide core may be selected from Eu₈Ti₁₀Oₓ and Eu₂Ti₄Oₓ.

In some embodiments, the novel polyoxotitanates may have one of the following formulae:

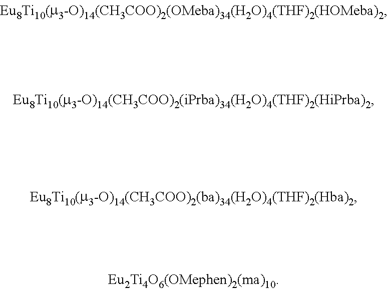

In another aspect, the invention also provides novel polyoxotitanates (POTs) comprising a core of titanium, oxygen and a lanthanide and comprising one or more light-harvesting ligands, wherein the POTs have a λₘₐₓ of up to 500 nm, for example a λₘₐₓ of ≤450 nm; ≤400 nm; or a λₘₐₓ of ≤350 nm. In some embodiments, the POTs may have a λₘₐₓ in the region of 250 to 500 nm, such as 300 to 500 nm, such as 300 to 450 nm, such as 300 to 350 nm.

The invention also provides a method of making polyoxotitanates in a droplet flow reactor. The method comprises: providing precursors comprising a lanthanide compound, a titanium-oxygen compound and a ligand; combining the precursors and a solvent in one or more precursor flows; injecting the precursors, a carrier fluid and an antisolvent into a tubular reaction vessel and allowing the precursors to react to form a polyoxotitanate; and collecting the polyoxotitanate as it exits the reaction vessel. The method of the invention offers a significant decrease in synthesis time for polyoxotitanate compounds (POTs) compared to known methods such as autoclave and Schlenk-type reactors, from hours to minutes. In addition, no extreme temperature or pressure is required and a pure product, confirmed by X-ray crystallography, can be obtained using the method of the invention.

The method may further comprise removing the carrier fluid. In an industrial setting, the carrier fluid may be recycled back to the start of the process.

The tubular reaction vessel may be coiled for thermal and spatial efficiency. The reaction temperature, i.e. the temperature inside the reaction vessel, may be up to 100° C., such as from 70 to 90° C., such as about 80° C. The reaction may be conducted at ambient pressure.

The residence time inside the reaction vessel, for example tubing, may suitably be no greater than 20 minutes, such as from 1 to 20 minutes, such as from 5 to 15 minutes, such as about 10 minutes, to achieve an appropriate yield from the reaction. Progress of the reaction forming POTs within the reaction vessel can be tracked by in-line fluorescence measurement and white crystal formation is visible by eye.

The flow rate of droplets in the tubular reaction vessel may suitably be from 0.030 to 0.250 ml/min, such as from 0.030 to 0.120 ml/min. The flow rate of droplets in the tubular reaction vessel may suitably be from 0.040 to 0.250 ml/min, such as from 0.040 to 0.120 ml/min.

The solvent, the antisolvent and the carrier fluid may each be selected based on the compound being manufactured. Suitable solvents for manufacturing POTs include tetrahydrofuran (THF), alcohols, methyl acetate and ethyl acetate. Suitable antisolvents include acetonitrile and hexane. Suitable carrier fluids include perfluorinated fluids such as Galden perfluorinated fluid, e.g. the HT series. Gases may also be used as carrier fluids.

A stoichiometric ratio of 1:1:5 of Eu(CH₃COO)₃:Ti(OiPr)₄:C₆H₅COOH may be used in the method of the invention (lanthanide compound:titanium-oxygen compound:ligand). Other stoichiometries may be used depending on the target product.

A stoichiometric ratio of 1:3 of precursor solvent:antisolvent may be used in the method of the invention. The amount of carrier fluid used in the method depends on the total flow rate of precursor and antisolvent.

The identity of the precursors is dependent on the POT being manufactured. The titanium-oxygen compound may suitably be Ti(OiPr)₄ or titanium bis(acetylacetonate)dichloride. The lanthanide compound may suitably be Eu(CH₃COO)₃ or Eu[(CH₃)₂CH(CO)₂]₃. The ligand may be a single type of ligand or two or more different types of ligand. Any ligand that can coordinate to the core and form a POT may be used. Depending on the end use of the POTs, suitable ligands include those based on polyaromatic nitrogen frameworks (such as bipyridines and phenanthrolines), phosphonate ligands, aliphatic and aromatic carboxylate ligands, alkoxides, acetonates, benzoates and methacrylate, amongst others. In some embodiments, suitable ligands may be selected from polyaromatic nitrogen frameworks (such as bipyridines and phenanthrolines), aliphatic and aromatic carboxylate ligands, alkoxides, acetonates, benzoates and methacrylate, amongst others.

The invention also provides use of a droplet flow reactor to manufacture polyoxotitanates. Previous methods for manufacturing POTs take a long time—on the scale of hours—making it expensive and inconvenient to scale up manufacture. Droplet flow synthesis of POTs takes minutes and can be easily scaled up, for example by providing parallel synthesis lines.

The invention also provides composite materials comprising polyoxotitanates dispersed in a polymer matrix. The polyoxotitanates are made according to the method of the invention or are the novel polyoxotitanates of the invention.

The polymer matrix may be one or more of polyethylene, polypropylene, polymethylmethacrylate, polycarbonate, polyether ether ketone, ethylene-vinyl acetate, acrylate, and polyvinylacetate.

The invention also provides polymer films comprising the composite material of the invention. The polymer film may be in the form of polytunnel sheeting. The polymer film may be in the form of a film for adhesion to greenhouse panels.

The invention also provides methods of manufacturing the composite materials of the invention. One suitable method is photopolymerization. The photopolymerisation method for manufacturing a composite polymer film comprises:
a. preparing a solution of monomers, polyoxotitanates and photoinitiator;
b. injecting the solution into a mould;
c. curing the solution in UV light; and
d. removing the cured composite polymer film from the mould.

Another suitable method is solution casting. The solution casting method for manufacturing a composite polymer film comprises:
a. preparing a solution of a polymer, for example PMMA, polyoxotitanates and solvent;
b. pouring the solution into a mould;
c. curing the solution by solvent evaporation;
d. removing the cured composite polymer film from the mould.

The invention also provides use of europium-containing polyoxotitanates in agriculture to increase the amount of red light available to plants. For photosynthesis, plants do not use the whole solar spectrum. The emission spectrum of Eu is well-matched to the wavelength requirements for photosynthesis. Eu-doped POTs absorb the shorter wavelengths that are not useful to plants and fluoresce at useful wavelengths. This increases the amount of useable photon energy for photosynthesis compared to the solar spectrum.

The invention also provides use of polyoxotitanates to increase the efficiency of a photovoltaic cell. The invention also provides the use of polyoxotitanates to decrease UV damage of an encapsulated material, such as an electronic component or a photovoltaic cell.

### BRIEF DESCRIPTION OF DRAWINGS

FIG. 1 shows a schematic of apparatus for droplet flow synthesis;

FIGS. 2A-H show molecular diagrams of examples of novel POTs of the invention;

FIG. 3 shows a schematic of use of POTs in agriculture;

FIG. 4 is a graph of absorption spectra for POT-polymer composite materials;

FIG. 5 is a graph of emission spectra for POT-polymer composite materials;

FIG. 6 is a graph of absorption spectra for POTs.

### DETAILED DESCRIPTION

### Definitions

“Spectral conversion” describes shifting electromagnetic radiation from one wavelength to another.

“Downconversion” is used herein to describe spectral conversion from a first wavelength to a longer wavelength.

“Downconverter” is used herein to describe a material that facilitates spectral conversion to a longer wavelength.

A polyoxotitanate is a molecular structure comprising a metal oxide core and a ligand shell, the metal oxide core comprising titanium and a lanthanide.

“Lambda max” and “λₘₐₓ” refer to the wavelength at which a material exhibits its highest level of absorption of electromagnetic radiation.

References to titanium oxide and to titania refer to any stoichiometry of titanium and oxygen.

### Abbreviations

4-terbutyl benzoic acid is referred to as “Htbba” and as “4-tBu benz”
4-methoxybenzoic acid is referred to as “HOMeba” and as “4-OMe benz”
4-isopropylbenzoic acid is referred to as “HiPrba” and as “4-iPr benz”
Benzoic acid is referred to as “Hba” and as “benz”
Methacrylate is referred to as “ma”
1,10-phenanthroline is referred to as “phen”
4,7-dimethoxy-1,10-phenanthroline is referred to as “OMe phen” and as “OMephen”
Polymethylmethacrylate is abbreviated to “PMMA”
Polyoxotitanate is abbreviated to “POT”
Photoluminescence quantum yield is abbreviated to “PLQY”
2,2′;6′,2″-terpyridine is abbreviated to “Terpy” or “Terpyridine”
Acetylacetonate is abbreviated to “acac”

### Novel Polyoxotitanates

Novel polyoxotitanates (POTs) have been developed, with particular benefits for agricultural applications. These POTs have a lanthanide fluorophore, protected by a titania core structure, and an organic ligand exterior.

The novel POTs can be modified in a modular way: the lanthanide may be swapped; the light-harvesting ligand may be swapped; and optional bridging or solubilizing ligands may be swapped or omitted.

In the modular structure, the light-harvesting ligand provides photon absorbance in a broader spectrum, and typically at longer wavelengths, than a lanthanide alone would do; the lanthanide controls the emission wavelength; the bridging ligand provides structural stability by reinforcing the existing bonds in the core; optionally the bridging ligand can provide compatibility with a surrounding material; optionally the bridging ligand can provide additional photon absorbance.

The metal oxide core of the novel POTs of the invention comprises titanium, oxygen and a lanthanide. The lanthanide is selected from europium (Eu), samarium (Sm), erbium (Er), terbium (Tb) and ytterbium (Yb), preferably selected from europium, samarium, erbium and terbium (Tb), most preferably europium. Experiments have shown that, for a given Ti—O-Ln stoichiometry, the structure of the core is the same regardless which lanthanide is used.

Europium alone has a lambda max of around 200 nm. This is too short a wavelength for efficient spectral conversion, because the greatest number of photons in solar radiation is found at around 400 nm. A similar problem is anticipated for the other lanthanides, especially Sm, Er and Tb.

The novel POTs comprise a metal oxide core and a ligand shell. The metal oxide core comprises Ti, O and a lanthanide selected from Eu, Sm, Er, Tb and Yb, preferably selected from Eu, Sm, Er and Tb; most preferably the lanthanide is Eu. The metal oxide core is essentially a titanium oxide cage with one or more of the titanium positions substituted with a lanthanide. The ratio of titanium to oxygen to the lanthanide in the core of the novel POTs is not important. Both large and small POT molecules have been found to be effective at downconverting solar radiation. References herein to “the lanthanide” or to a specific lanthanide element should be interpreted as one or more lanthanide atoms in the core of the POT unless specified otherwise.

Examples are provided herein for novel POTs comprising Eu and another comprising Yb. Samarium, erbium and terbium are expected to perform in the same manner as europium based on their known emission in the red.

The size and stoichiometry of the Ti-Lanthanide-O core cage is not especially important. The association of the lanthanide and the light-harvesting ligand(s) creates the photochemical properties of the POT. In particular, the quantum yield is not dependent on the relative amount of the lanthanide in each POT molecule and instead is dependent on the alignment of energy levels between the lanthanide and the light-harvesting ligand(s), and the absorption coefficient of the light-harvesting ligand(s).

The titanium oxide cage protects the coordination of the lanthanide with its light-harvesting ligands so that the interaction can be retained, for example when the POTs are dispersed in a polymer matrix. Compared to a lanthanide-ligand complex, the novel POTs are believed to have increased quantum yield; reduced vibration losses and non-radiative losses; improved stability and resistance, for example resistance to UV degradation; and increased molecular rigidity.

The ligand shell comprises at least one type of ligand, this essential ligand being a light-harvesting ligand (antenna ligand). The light-harvesting ligand is coordinated to the lanthanide in the core of the molecule. This has the effect of increasing the lambda max for the POT, bringing it nearer to 400 nm, thereby increasing the efficiency of the spectral conversion achieved by the POT.

The light-harvesting ligands change the absorption spectra of the POT compared to the metal oxide cage absent any light-harvesting ligands. With just the Ti-Ln-O core, the absorption spectrum is not optimum because it is too far towards shorter wavelengths, at around 200 nm for Eu. Solar radiation has maximum photons at around 400 nm, therefore it is beneficial to have λₘₐₓ as close as possible to 400 nm so as to maximise the energy emitted at a longer wavelength.

The light-harvesting ligands are preferably all or mostly associated with the lanthanide atoms in the core, for example bonded to the lanthanide. This ensures efficient energy transfer from the ligand to the lanthanide fluorophore. Light-harvesting ligands associated instead with Ti or O in the core are less efficient at transferring solar energy to the lanthanide, thereby decreasing the quantum yield. This is because an extra energy transfer step is required, that is omitted when the light-harvesting ligands coordinate directly to the Eu. For example, a phenanthroline ligand may absorb a photon and transfer the energy directly into the f electronic state of a Eu atom in the core cage, to which it is coordinated. Preferably, the light-harvesting ligands coordinate only to lanthanide, not to titanium or oxygen.

The ligands preferably coordinate only to the outer sphere of the core, not within the core metal oxide cage.

Preferably, the light-harvesting ligand is a bi-dentate or tri-dentate chelating ligand.

Preferably, the light-harvesting ligand binds to the lanthanide via N, O, or both, the N and the O being a part of the ligand. This is because N- or O-bonding will be strong with a lanthanide (hard-hard interaction), whereas bonding to, for example, S— or P— would be much weaker.

Preferably, the light-harvesting ligand belongs to any of the following classes of compounds:
a. 2-quinolines with a substituent in the 8-position
b. Quinones
c. Substituted 2,2′-bipyridines
d. 1,10-phenanthrolines (substituted only)
e. Naphthyridine
f. Anthraquinones
g. Catechols
h. Acetylacetonates (acac)
i. 2,2′;6′,2″-terpyridine (terpy)

For example, the light-harvesting ligand may be selected from any of the following classes of compounds:
a. 2-quinolines with a substituent in the 8-position
b. Quinones
c. Substituted 2,2′-bipyridines
d. 1,10-phenanthrolines (substituted only)
e. Naphthyridine (for example, 1,8-naphthyridine)
f. Anthraquinones
g. Catechols
h. Acetylacetonates (acac)

In some embodiments, the light-harvesting ligands are selected from substituted 1,10-phenanthrolines and acetylacetonates.

Other suitable light-harvesting ligands include substituted and unsubstituted mono- and polycyclic aromatic ligands, for example ligands based on benzene, naphthalene, biphenyl, fluorene, anthracene, phenanthrene, phenalene, tetracene, chrysene, pentacene, benzo[c]fluorene, quinoline, quinazoline, quinoxaline, indole, indazole, carbazole, benzocarbazole, acridine, benz[a]acridine, benzimidazole, purine, cinnoline, phenanthridine, phenanthroline, and others.

In some embodiments, the light-harvesting ligands are selected from substituted and unsubstituted phenanthroline and substituted and unsubstituted benzoate ligands. These ligands in combination with the lanthanide-Ti—O metal-oxo core cage, especially an Eu—Ti—O metal-oxo core cage, have been found to exhibit excellent quantum yield.

In order to make them useful for application in agriculture, the novel POTs may also comprise means for solubilization in a polymer matrix. This may be either a moiety of the light-harvesting ligand, or a co-ligand such as methacrylate. Preferred moieties for solubilization include C₁₂₋₁₈ branched and linear alkyl and alkoxy groups. The moiety or co-ligand for solubilisation may be selected based on compatibility with the polymer in which the POT is to be dispersed. For example, a methacrylate co-ligand is especially useful for solubilizing POTs in PMMA.

Preferably, the POTs comprise one or more bridging ligands. Bridging ligands coordinate with at least two atoms in the core; this may be coordination to two or more titanium atoms or coordination to both a titanium and a lanthanide. This reinforces the strength of the core compared to a POT with no bridging ligands. Bridging ligands which form a -Ln-O—C—O—Ti— bridge with the core have been found to be especially beneficial for reinforcing the strength of the core structure.

A solubilising ligand may be a bridging ligand if it coordinates to two or more atoms in the core of the POT.

An optional, secondary function of the bridging ligand(s) is to improve compatibility with a surrounding material, such as a polymer resin into which the POT may be incorporated.

An optional, tertiary function of the bridging ligand(s) is light-harvesting. Light-harvesting (excitation of the ligand by photons and transfer of the excitation energy to a lanthanide atom in the core of the POT) via a bridging ligand is less efficient than via the light-harvesting ligand, because there is more separation between the aromatic system of a bridging ligand and the lanthanide. Thus, if a ligand such as benzoate, which has excitation capability, is used in the POT, it is preferred that this is in addition to a light-harvesting ligand such as phenanthroline, the latter of which can coordinated directly and solely to a lanthanide in the core and thus provide more efficient energy transfer.

In some embodiments, bridging ligands are bound via one or more of the following functional groups:
a. Carboxylate
b. Acetylacetonate (acac)
c. Alcoholate

In some embodiments, the side chains of the bridging ligands help with compatibility to the surrounding material in a POT composite. Compatibility may be facilitated by an side chain selected from an alkyl chain and/or a poly(alkyleneglycol), such as poly(ethylene glycol).

In some embodiments, bridging ligands contain one or more of the following functional groups: hydrogen, hydroxyl, alkene, and alkyne.

In some embodiments, the one or more bridging ligand comprises benzoate, acrylate, octanoate, or a combination thereof.

In some embodiments, the one or more bridging ligand comprises or consists of an alkanoic acid. Suitable alkanoic acids may include C₁₋₁₈ alkanoic acids, such as C₁₋₁₀ alkanoic acids. The length of the alkyl group may be chosen based on compatibility with the surrounding material into which the POT is to be incorporated. In some embodiments, the one or more bridging ligands comprises or consists of octanoate.

In principle, ligands derived from acac may be used as light-harvesting ligands, as bridging ligands, or both. The reaction with the Ti-Ln-O core may be controlled such that the ligand coordinates with two of the acac oxygens to a single Ln atom, or such that the ligand coordinates to a Ti and a Ln, or to two Ti in the core. For example, an unsubstituted acac with a long side chain may be introduced first as a bridging ligand, then a substituted acac with an aromatic substituent(s) may be introduced second as a light-harvesting ligand.

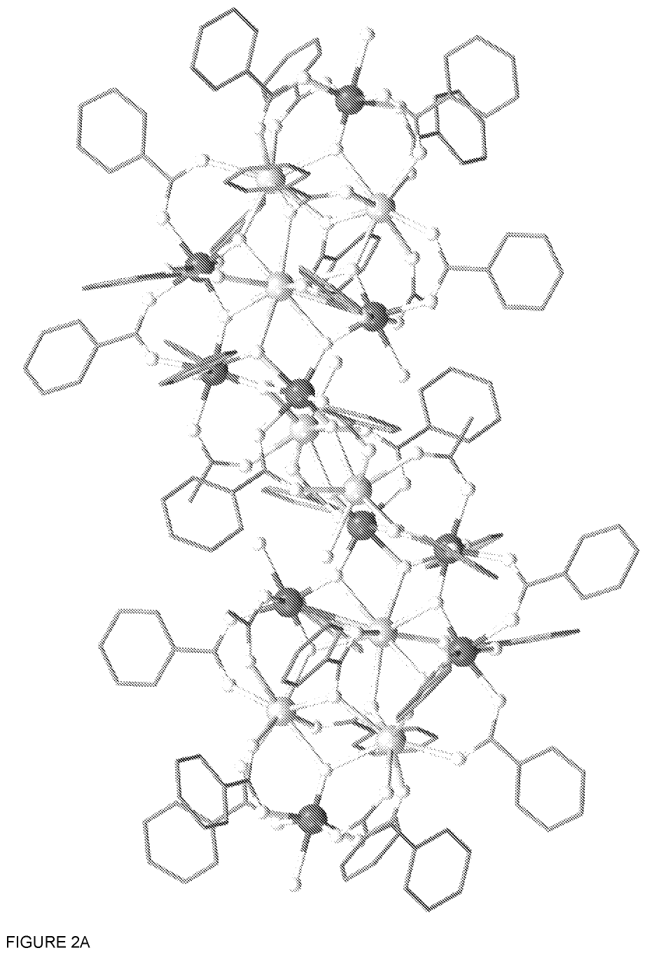

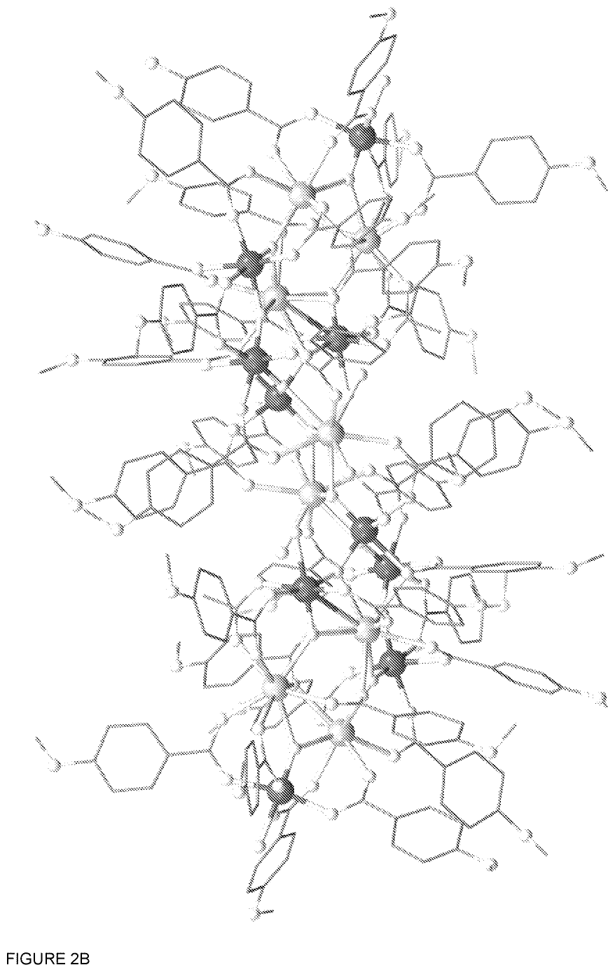

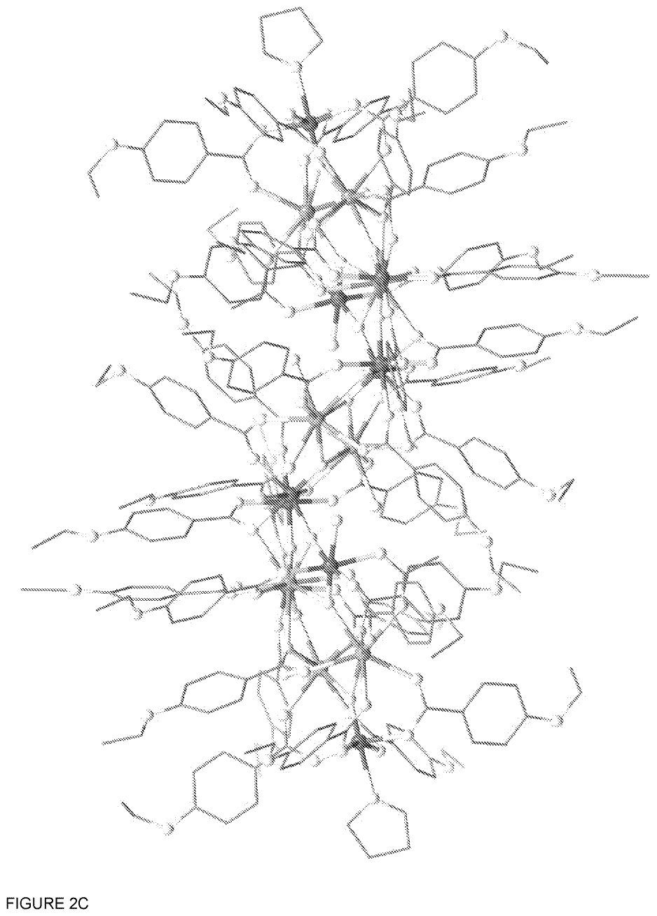

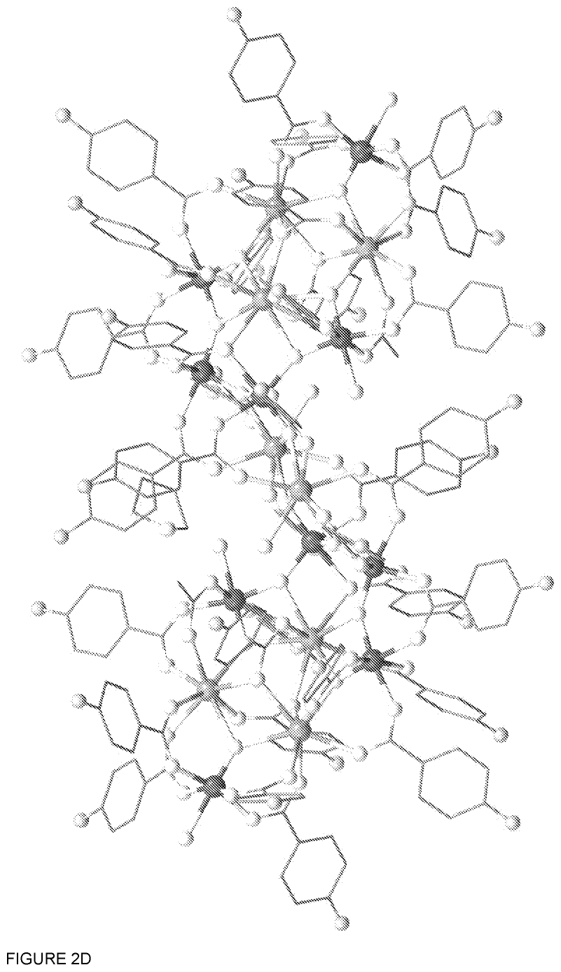

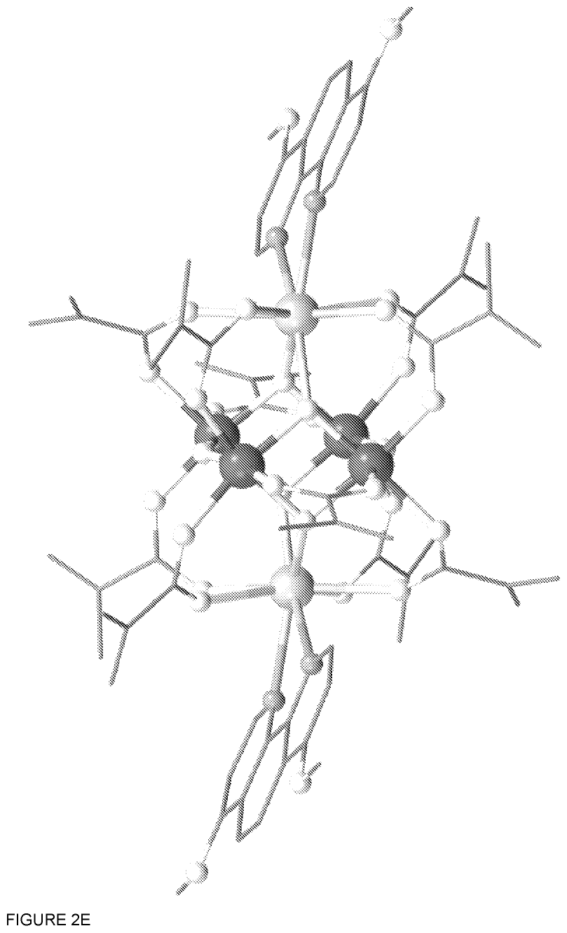

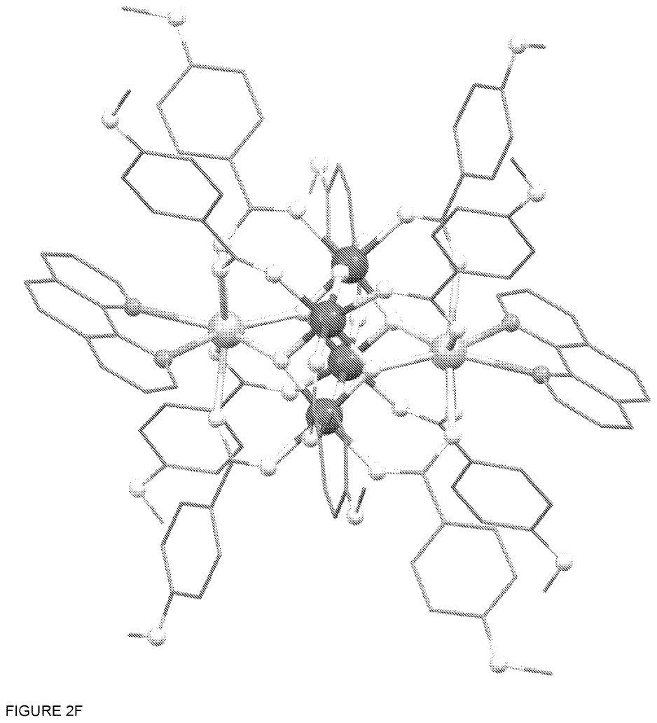

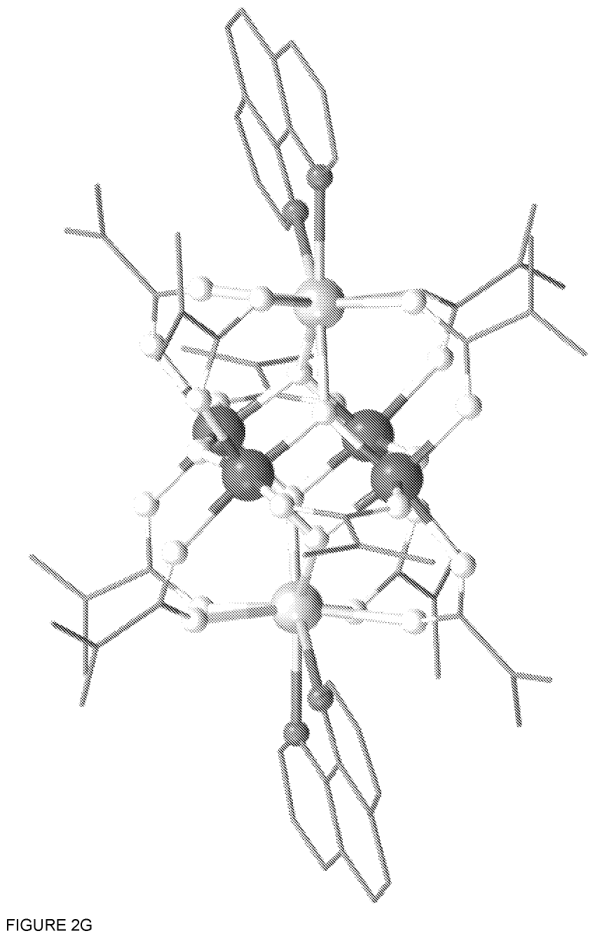

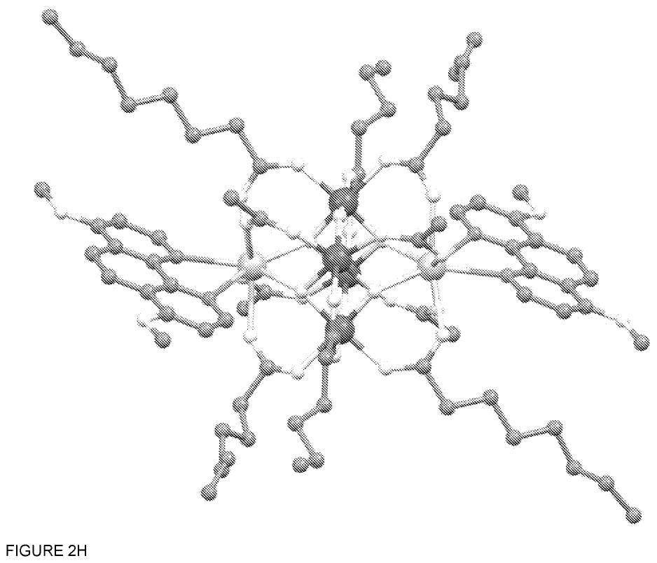

Selected novel POTs according to the invention are illustrated in FIGS. 2A-H.

FIG. 2A shows a ball-and-stick representation of the structure of an Eu₈Ti₁₀ cage with benzoate (PhCO₂) cage groups. C-atoms are depicted in wire-frame form, Eu (large grey balls), Ti (dark grey balls), 0 (small white balls). H-atoms and lattice solvent molecules have been omitted for clarity.

FIG. 2B shows a ball-and-stick representation of the structure of an Eu₈Ti₁₀ cage with 4-methoxy-benzoate (4-MeO-PhCO₂) cage groups. C-atoms are depicted in wire-frame form, Eu (large grey balls), Ti (dark grey balls), O (small white balls). H-atoms and lattice solvent molecules have been omitted for clarity.

FIG. 2C shows a ball-and-stick representation of the structure of an Eu₈Ti₁₀ cage with 4-ethyoxy-benzoate (4-EtO-PhCO₂) cage groups. C-atoms are depicted in wire-frame form, Eu (large grey balls), Ti (dark grey balls), O (small white balls). H-atoms have been omitted for clarity.

FIG. 2D shows a ball-and-stick representation of the structure of an Eu₂Ti₄ cage with 4-fluoro-benzoate (4-F-PhCO₂) cage groups. C-atoms are depicted in wire-frame form, Eu (large grey balls), Ti (dark grey balls), O (small white balls), F (small grey balls). H-atoms have been omitted for clarity.

FIG. 2E shows a ball-and-stick representation of the structure of an Eu₂Ti₄ cage with methacrylate (CH₂═C(Me)CO₂) cage groups and 4,7-dimethoxy-phenanthroline light-harvesting ligands attached to Eu. C-atoms are depicted in wire-frame form, Eu (large grey balls), Ti (dark grey balls), O (small white balls), N (light grey balls on phenanthroline ligands). H-atoms and lattice solvent molecules have been omitted for clarity.

FIG. 2F shows a ball-and-stick representation of the structure of Eu₂Ti₄ cage with 4-methoxy-benzoate (4-MeO-Ph) cage groups and phenanthroline light-harvesting ligands attached to Eu. C-atoms are depicted in wire-frame form, Eu (large grey balls), Ti (dark grey balls), O (small white balls), N (light grey balls on phenanthroline ligands). H-atoms and lattice solvent molecules have been omitted for clarity.

FIG. 2G shows a ball-and-stick representation of the structure of Yb₂Ti₄O₆(phen)₂(ma)₁₀. H-atoms have been omitted for clarity. This Yb-based POT may be used in photovoltaic encapsulation to improve the efficiency of a solar cell, because its emission is in the region of 900 nm.

FIG. 2H shows a ball-and-stick representation of an Eu₂Ti₄ core structure, with 4,7-dimethoxy-1,1-phenanthroline light-harvesting ligands and octanoate bridging ligands. H atoms have been omitted for clarity.

The structure of FIG. 2G demonstrates that the Ti₄Eu₂ cage structure can be adapted to other lanthanides. The synthetic route is the same as for POTs using Eu as the lanthanide. Other POT cages having the same structural arrangement as Eu₂Ti₄O₆(OMephen)₂(ma)₁₀ containing Sm, Yb and Er have been synthesized, as exemplified by the Yb³⁺ cage Yb₂Ti₄O₆(phen)₂(ma)₁₀ (Sm and Er cages not pictured).

The benzoate; 4-methoxy-benzoate; 4-ethyoxy-benzoate; 4-fluoro-benzoate; 4,7-dimethoxy-phenanthroline; and phenanthroline ligands shown in FIGS. 2A-F, respectively, are coordinated to Eu in the core (the Eu in the Eu₈T₁₀ cages and the Eu₂Ti₄ cages) and capture incident light. The direct coordination of these ligands, known herein as “light-harvesting” ligands and as “antenna” ligands, allows for efficient energy transfer to Eu, reducing the possibility for losses such as vibrational losses. Also shown in FIG. 2E, although not essential to the invention, are methacrylate solubilising co-ligands (methacrylate cage groups). These improve the solubility of the POT in a polymer matrix. The same function can be achieved by moieties that are part of the light-harvesting ligands, for example alkoxy or alkyl groups.

### Droplet Flow Synthesis

The inventors have developed an improved synthesis route for POTs, using droplet microfluidics. Droplet microfluidic technology in general is known. However, this technology has not been implemented for POT manufacture.

Suitable solvents include THF and alcohols. The solvent is chosen so that the precursors can dissolve in the solvent and react with each other and so that the product has a low enough solubility to come out of solution when formed.

Suitable antisolvents include acetonitrile and hexane. The antisolvent is added so that the product crystallises out of solution and a crystalline powder is obtained directly from the reactor.

The carrier fluid can be liquid or gaseous. Suitable carrier fluids include perfluorinated compounds such as the Galden perfluorinated HT series and inert gases. The carrier fluid is an immiscible liquid or gas that causes the reagent phase to separate into a line of discrete, near-identical, low-volume droplets that passes through the channel at a regular speed. Due to their small (usually sub microlitre) volume, the droplets are exceptionally uniform with respect to chemical composition and temperature, and so provide an extremely controlled environment for chemical reactions. In the case of the perfluorinated liquid, the droplets are kept away from the channel walls by this liquid. This effectively lubricates the channel wall and prevents fouling due to precipitation of reactants or products on the channel wall. This ensures a constant, unchanging reaction environment. The carrier fluid must be inert and immiscible with all other components in the reaction mixture, so that the solvents and reactants can form droplets.

The precursors used depend on the product being synthesised. For Eu-doped polyoxotitanates, suitable precursors include Eu(CH₃COO)₃; Eu[(CH₃)₂CH(CO)₂]₃; Ti(OiPr)₄; titanium bis(acetylacetonate)dichloride; and ligand compounds. Other suitable precursors include but are not limited to Eu(Ill) thenoyl trifloroacetonate (TTA), Eu(Ill) trifluoromethane sulfonate (CF₃SO₃), and Eu(Ill) triflorophenyl-1,3-butadione (BTFA). Depending on the POTs being manufactured, other lanthanides may be used, such as Samarium, Terbium, Erbium and Ytterbium.

The droplets may be brought up to the reaction temperature by any suitable method, such as a brass heating rod or an oil bath.

A droplet flow reactor for use in the method of the invention may comprise a mixing junction. Precursors dissolved in solvent may be flowed into the mixing junction with a carrier fluid. The carrier fluid creates droplets, each of which functions as a miniature chemical reactor in which the precursors react to form the desired POT. The droplets provide an efficient environment in which the reaction occurs: reaction times of 3 to 10 minutes are possible for POT synthesis, which offers a significant time saving compared to conventional methods, which are on the scale of hours for synthesis of the same products. The residence time in the reactor depends on both the flow rate and the tubing length and can be significantly longer if desired, up to a few hours. The progress of the reaction can be measured by in-line fluorescence, by virtue of the unique photoluminescence properties of the product. A flow rate of from 0.030 to 0.250 ml/min, such as from 0.040 to 0.250 ml/min, may suitably be used. In addition, the POT forms as a white crystalline product, which is visible in the droplets with the naked eye.

The POT product may be collected and separated on exit from the reactor tubing, as a crystalline powder.

Another major benefit of this synthesis route is that it can be conducted at ambient pressure, making it both environmentally and economically efficient compared to known POT synthesis routes.

The carrier fluid may be a liquid or a gas. Gaseous carrier fluids are preferred because they are both cheaper and cleaner than liquid carrier fluids, but the method can be implemented with either.

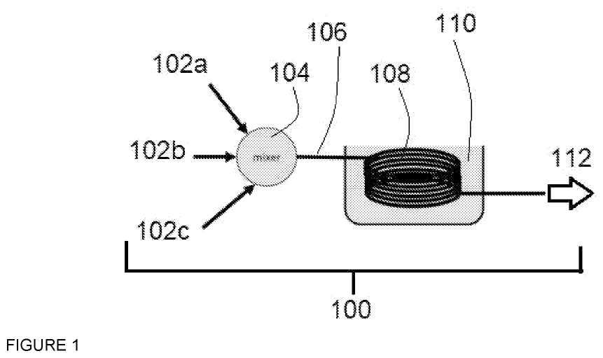

A suitable apparatus for use with the method is illustrated schematically in FIG. 1. Droplet flow reactor 100 comprises injection inlets 102a, 102b and 102c. The number of injection inlets may be varied depending on precursors, solvents, antisolvents and carrier fluids used. In mixer 104 (mixing junction), droplets are formed, each droplet comprising all of the precursors and acting as a microreactor. The droplets travel through tubing 106, which may be coiled as shown at 108. The temperature in the coil 108 can be controlled by any suitable means, such as oil bath 110 or a central heating element within the coil 108 (not shown). A temperature of 80° C. is sufficient for POT synthesis in droplet flow reactor 100. Although coiling 108 is efficient for temperature control and space, it is not essential for the synthesis to complete and other configurations for droplet flow reactor 100 are possible. The POT product is collected at 112 on exit from tubing 106. The carrier fluid may be recycled back to the start of the process (not shown).

### POT-Polymer Composite Materials

POTs can be dispersed in a polymer matrix, to make them usable for a variety of applications. Previous means for photoluminescence have involved quantum dots or organic dyes. Compared to quantum dots, which need to have special manufacturing controls to make and maintain them in a monodisperse state, POTs are molecules, therefore are always monodisperse. Compared to organic dyes, which suffer from photobleaching, POTs are stable over time when subjected to light, because the fluorophore is inorganic, i.e. a lanthanide.

Polymer matrices may quench the luminescent properties of a simple lanthanide-ligand complex by changing the coordination environment of the lanthanide and its ligands. The use of POTs overcomes this drawback, because the coordination of the lanthanide and its ligands is protected by the rigid Ti—O-Lanthanide core framework, thereby maintaining the photophysical characteristics of the lanthanide in the core.

Furthermore, the substitution of the ligands, for example benzoate ligands, does not alter the structure of the metal oxide core. This means that absorption spectrum effects can be tied to the ligands used for a single type of metal oxide core cage.

The PLQY of POTs outside of a polymer matrix is usually greater than that achieved within a polymer matrix. However, whilst POTs alone are interesting in a laboratory setting, solubilizing POTs into a polymer matrix renders them useful in a variety of real-world applications whilst still achieving a good PLQY.

POTs may be dispersed into a variety of polymers. Any polymer that may be made into a substantially transparent film, coating or sheet may be implemented. Suitable polymers include polyethylene (PE), polypropylene (PP), polymethyl methacrylate (PMMA), polycarbonate (PC), ethylene-vinyl acetate (EVA), acrylates such as acrylate paint, and polyvinyl chloride (PVC). For example, polytunnels used in agriculture are typically made from PE. The plants grown within may benefit from increased amounts of light in the wavelength range that is suitable for photosynthesis, if a POT-PE composite film was used instead of conventional PE. PC is used today for glass alternatives and may be used for greenhouse panels. Similar to a polytunnel, plants inside a greenhouse utilizing POT-PC composite panels may benefit from increased amounts of the best wavelengths of light for photosynthesis. POT-polymer film composites and paint-type coatings may be made to retrofit existing greenhouses, without needing to replace the panels, for the same benefit.

POT-polymer composites may be manufactured by any suitable polymer processing route. For example, solution casting, photopolymerization, extrusion, and others.

The POT-polymer composites of the invention are preferably substantially transparent in the visible spectrum.

The thickness of the POT-polymer composites may be selected based on the end use application. For example, polytunnel sheeting may have a thickness of approximately 150-200 μm; siding materials may have a thickness of approximately 1-10 mm; paint-type coatings may have a thickness of approximately 1-500 μm, such as 1-300 μm, for example 30-300 μm or 1-10 μm.

### Applications of the Invention

The composites and the novel POTs of the invention are particularly suitable for agricultural application. Plants that are grown in polytunnels or in greenhouses may benefit from increased amounts of light in the wavelength range that is useful for photosynthesis, when POTs are implemented in greenhouse panels or in polytunnel films. Greenhouse panels may be rigid plastic, with POTs dispersed in the rigid plastic, or alternatively glass or any other rigid transparent material, with a POT-polymer composite film disposed thereon.

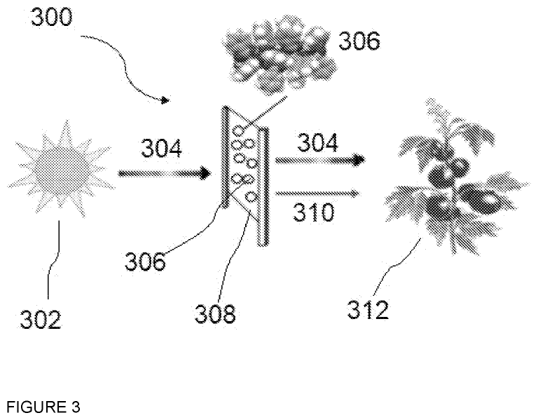

A schematic of how the invention may be implemented in agriculture is shown in FIG. 3. A downconverter panel 300 is placed between the Sun 302 and a plant 312. The panel 300 comprises POTs 306 dispersed in a film or panel 308. Solar radiation passes through the panel 300 to the plant 312. Incident solar radiation has a wavelength spectrum 304. Some of the incident light passes through panel 300 unchanged. Some of the light is absorbed by the POTs and emitted at longer wavelength 310. The proportion of useful wavelength radiation 310 is increased for the plant by the POTs 306 in the panel 300. The energy available for photosynthesis is thus increased compared to a panel without POTs.

The inventive compounds may be used in a coating or paint. A coating or paint according to the invention comprises the POTs described above and/or POTs made according to the method described above. A coating or paint according to the invention is preferably transparent or translucent. The coating or paint may be used, for example, to retrofit a greenhouse with spectral downconversion capability, by applying the coating or paint to an existing greenhouse panel. This may be more practical than replacing existing panels and provides a quick and convenient method by which to increase agricultural efficiency. The paint or coating may be applied in applications other than agriculture, for example, but not limited to, UV protection for buildings and vehicles; art installations; safety signage; and other applications.

A non-limiting method of manufacturing a coating or paint in accordance with the invention is as follows:

A solution of the desired polyoxotitanate (POT) in acrylic paint in ethanol is prepared by diluting the paint in the ethanol and then adding and combining the POT into the diluted paint. A suitable ratio is about 1 to 15 mg of POT per gram of acrylate in the paint, for example 37.5 mg of POT per 5 g of paint, to give a final concentration of 15 mg of POT per g of acrylate. The ratio of paint to ethanol is not particularly limited. A suitable ratio is 2 ml of ethanol in 1 g of paint. The mixture of paint, ethanol solvent and POT is stirred for approximately 10 hours, depending on the amounts and ratios of reagents, in a sealed vessel to prevent solvent evaporation. The solution is then coated onto a substrate, for example by pouring, spraying, dip coating, spin coating or another method. The substrate may be any suitable substrate, for example a glass plate. The coated substrate is covered to avoid dust settling in the solution, and is left to evaporate and dry, for example for at least 24 hours. The residual material forms a transparent film. The film thickness may typically be 0.03 to 0.3 mm thick, depending on the amounts and concentrations used in the preparation of the solution.

POTs and the POT composite materials described above can be used to absorb UV light for the protection of entomopathogenic fungi, such as Beauveria bassiana conidia, which are widely used for pest control.

The inventive compounds may be used as a fluorescent chemical in any suitable application. Currently-known fluorescent compounds may be substituted in part or in full by the inventive compounds.

In an agriculture setting, the novel POTs may be used to increase the availability of red light for photosynthesis, for example when implemented in a polytunnel film, or a paint, coating, film or panel for greenhouses. For agriculture, it is preferred that the lanthanide is selected from Eu, Sm, Er and Tb, especially Eu, due to the emission of these lanthanides in the red region.

The inventive materials may be implemented in a healthcare capacity. It is known that evening exposure to blue light disrupts the circadian rhythm. The inventive materials may be used to convert ambient light to a longer wavelength, thereby increasing the availability of red light and decreasing the amount of blue light. The inventive materials may be implemented in this setting as, for example, coatings for spectacles lenses; lampshades, lightbulbs, LEDs, GaN-based lights and other types of light; computer and other device screen filters; window coatings; and other such devices.

Some high-value objects and devices deteriorate over time when exposed to UV radiation. Such objects and devices may be encapsulated in an encapsulant, such as a polymeric encapsulant. The inventive materials may be incorporated into an encapsulant to reduce or prevent UV damage to an encapsulated item. For example, a circuit board may be encapsulated in a polymer incorporating the inventive materials.

The inventive materials may be used to prevent or retard UV damage to a polymer into which they are incorporated. For example, a polytunnel film, typically used for agriculture, experiences high solar UV exposure, which deteriorates the polymer over time. Incorporating the inventive materials into the polymer film may retard this degradation, by converting the harmful UV radiation to longer wavelengths. Other polymeric materials exposed to the elements may similarly benefit from incorporation of the inventive materials.

The inventive materials may be used in display technologies. Quantum dots and other materials currently in use for display technologies are rather costly and could be replaced in part or in full by the inventive compounds.

The inventive material may be used in 3D printing filaments. Typically, a plastic such as PLA, PTE, ABS, etc. contains a dye or pigment to give colour to the polymer and thereby to the printed product. The dye or pigment may be replaced or supplemented by POTs, resulting in a filament that glows under UV. Such a filament may be prepared in a manner similar to that described above with respect to POT-containing films: compounding and extruding polymer and POTs into a masterbatch, adjusting the concentration as required; extruding to a filament ready for 3D printing.

The inventive materials can be used to prevent the degradation of silicon-based wafers in solar panels from UV, as well as other UV sensitive materials in photovoltaic panels, such as perovskites. Similarly, POTs can be used to protect the same materials in other applications that make use of them, including detectors.

Other uses of the inventive materials are contemplated, such as solar photovoltaic encapsulation; sensors, such as light detectors; fluorophores for bioassays; UV protection; lighting; encapsulants; screens and displays, for example televisions and device screens; toys; hazard signs; paints, for example for the creative and construction industries; printing inks; suncream; tattoo inks; glow sticks; security paint; anti-counterfeit measures; and luminescent material for clothing. The application examples presented here are merely illustrative of the myriad benefits of the invention and are not limiting on the scope of the claims.

### EXAMPLES

### Example 1: Production of a Downconverter Polymer Product Using Solution Casting

A solution of the desired polyoxotitanate (POT) in polymethylmethacrylate (PMMA) in dichloromethane and toluene is prepared by first dissolving the POT in dichloromethane, then adding toluene and PMMA. The molecular weight of PMMA may be approximately 350,000, but this is not critical for the process. Typical ratios are 1-10 mg of POT per g of PMMA (e.g., 25 mg of POT per 5 g of PMMA for a final concentration of 5 mg of POT per g of PMMA). Per g of PMMA, typically 4 ml of dichloromethane and 4 ml of toluene are used, but the ratios and amounts can be varied if needed.

The POT/PMMA/solvent mixtures are stirred until a clear solution is obtained, approximately two hours, depending on amounts and ratios of reagents.

The solution is poured into an open-top mould consisting of a glass plate (the bottom of the mould) and a “border” on 4 sides made from polytetrafluoroethylene of defined thickness (typically 2 mm, but other sizes can be used as desired).

The mould is covered to avoid dust falling into the solution and left to evaporate for at least 24 hours.

The residual material forms a transparent film; typical thickness is 0.1-0.5 mm, depending on the amounts and concentrations used in the preparation of the solution.

### Example 2: Production of a Downconverter Polymer Product Using Photopolymerization

A solution of polyoxotitanate in a mixture of acrylate monomers is prepared. The mixture of acrylate monomers is not crucial. A suitable mixture is 60 wt % isobornyl methacrylate, 30 wt % isodecyl acrylate and 10 wt % 1,6-hexanediol dimethacrylate.

A solution of photoinitiator in the same acrylate formulation is added to the polyoxotitanate solution. The type of photoinitiator and its concentration in the acrylate solution is not crucial. A suitable example is 1 wt % 2-hydroxy-2-methyl-1-phenylpropanone, commercially available as SpeedCure 73 from Sartomer.

A suitable ratio of the polyoxotitanate solution to the photoinitiator solution is 90:10 by volume. This ratio is not critical for the production method. The final concentration of polyoxotitanate in acrylate may be in the range of 1-10 wt %, e.g. 5 mg of POT in 1 g of acrylate.

The solution is degassed to remove oxygen from the mix, for example by repeated application of vacuum and re-filling the vessel with an inert gas such as argon or nitrogen.

The degassed solution is then injected into injection moulds consisting of two glass plates separated by a polytetrafluoroethylene spacer of suitable size and thickness (typically 0.05-1 mm). The bottom glass plate is typically made of borosilicate glass that has either been pre-treated to release the resulting film (by application of a perfluorosilane coating, e.g. trichloro (1H, 1H, 2H, 2H-perfluorooctyl)silane)) or to bond with the resulting film (by application of a polymerizable silane coating, e.g., 3-(trimethoxysilyl)propyl methacrylate. The top glass plate is typically made from fused silica (“quartz”) glass, into which two holes had been drilled to allow for injection of the monomer mix. This top plate will also typically have been treated with a suitable perfluorosilane coating to facilitate the release of the resulting film.

The filled moulds are then placed under a suitable UV light source (compatible with the photoinitiator used) and cured, typically from 10-120 minutes.

### Example 3: Absorbance and Emission of a Downconverter Polymer Product

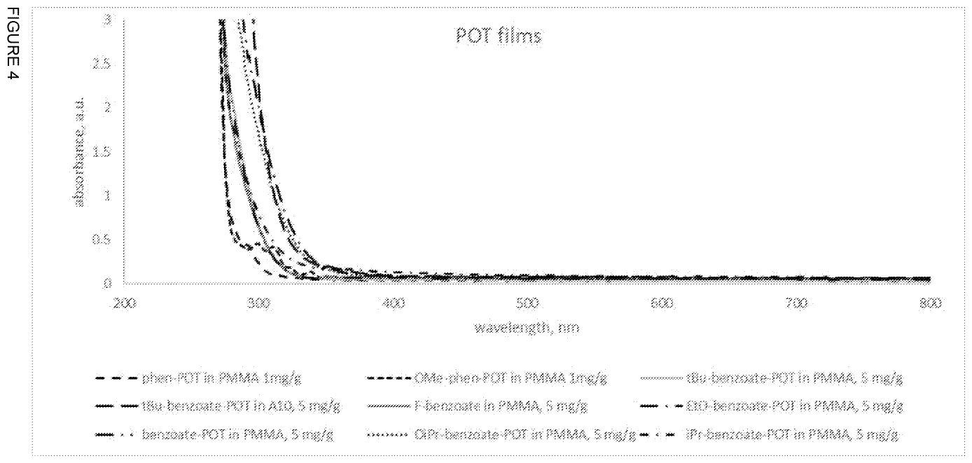

The emission spectrum of the downconverters of the invention are controlled solely by the lanthanide in the core of the POTs. The matrix material, its thickness, the concentration of the POTs and the exact formula of the POTs are all irrelevant for the emission spectrum. The emission spectra of an example POT in PMMA matrix are shown in FIG. 5.

The absorbance spectrum of the downconverters of the invention is influenced by both the lanthanide in the core and the light-absorbing ligands in the shell of the POTs.

The lambda max of a europium-titanium-oxygen complex without any ligands is approximately 200 nm. The type of ligands in the shell and the manner in which they are coordinated to the metal oxide core affect the absorption spectrum of the overall compound.

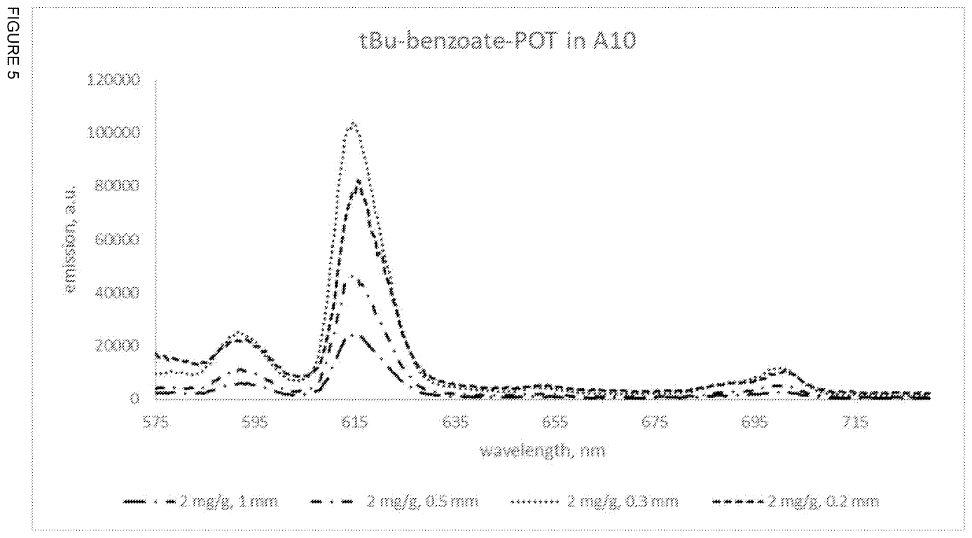

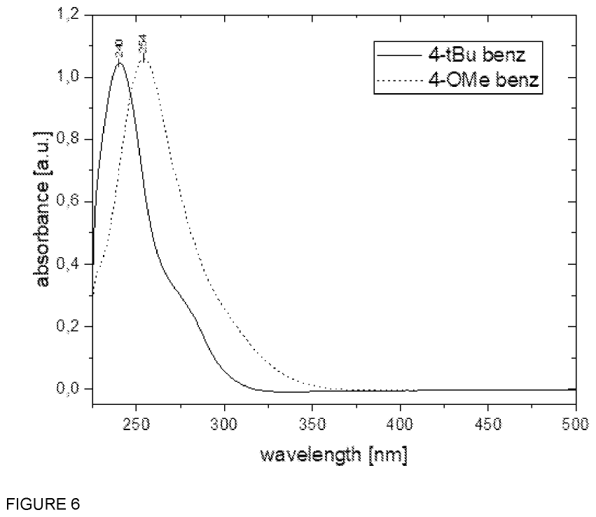

FIG. 6 shows the spectra of a known POT having 4-tBu benzoate ligands and new POT having 4-OMe ligands. The lambda max of the new compound is shifted closer to 400 nm, which is desirable in order to capture more photons from incident solar radiation to be emitted at longer, red wavelengths.

### Example 4: General Method for Synthesising POTs Using Droplet Flow Synthesis

Weigh La(OAC)₃ (e.g. Eu(OAC)₃) and ligands into a vial, add solvent (e.g. tetrahydrofuran) and Ti(OiPr)₄ and sonicate for 30 mins to achieve complete dissolution. These precursors may be all combined, or alternatively two precursor flows may be used;
Load precursors into syringe(s);
Add antisolvent (e.g. acetonitrile or hexane) into another syringe;
Place carrier fluid (e.g. a perfluorinated fluid) into a separate syringe;
Place the syringes on different pumps and connect via tubes (e.g. perfluoroalkoxy tubing) to the mixer (e.g. a 9 meters long PFA tube, immersed in a temperature-controlled oil bath);
Set the desired temperature and flow rate;
Start the experiment and collect the product as it flows out of the system;
Remove the carrier fluid and prepare the sample for characterisation.

Droplet flow synthesis such as this method is suitable for the novel POTs of the invention as well as POTs in general, including those already known in the literature.

A schematic of the apparatus is shown in FIG. 1.

The following POTs were made using this general method, with residence time and temperature in the reactor as indicated. The first two compounds are known in the literature, but have significantly longer synthesis times when using conventional methods such as autoclave and Schlenk-type reactors. X-ray diffraction confirmed that these compounds made via droplet flow synthesis were the same as made when via conventional synthesis routes.

| | | Residence | | Conventional |
|---|---|---|---|---|
| Polyoxotitanate | Ligand | time | Temperature | method* |
| Eu₂Ti₄C₁₄₂O₃₂H₁₇₀ | 4-terbutylbenzoic acid | 3 minutes | Room | 12 hours |
| | | | temperature | |
| Eu₈Ti₁₀C₄₀₈O₉₆H₅₀₀ | 4-terbutylbenzoic acid | 10 minutes | 80° C. | 10 hours |
| Eu₈Ti₁₀ | 4-isopropylbenzoic acid | 10 minutes | 80° C. | |
| Eu₈Ti₁₀C₂₅₄O₉₄N₂H₁₇₂F₃₄ | 4-fluorobenzoic acid | 10 minutes | 80° C. | |
| Eu₈Ti₁₀ | benzoic acid | 10 minutes | 80° C. | |
| C₆₄H₅₆EuO₃₀Ti₄ | 4-methoxybenzoic acid | 10 minutes | 80° C. | |
| H₅₀₃Eu₁₆Ti₂₀C₅₆₂O₂₅₂N₅ | 4-methoxybenzoic acid | 10 minutes | 80° C. | |
| Eu₈Ti₁₀ | 4-ethoxybenzoic acid | 10 minutes | 80° C. | |
| Eu₈Ti₁₀ | 4-iso-propoxy-benzoic acid | 10 minutes | 80° C. | |

*data from Inorg. Chem. 2017, 56, 20, 12186-12192, Sep. 28, 2017; DOI: 10.1021/acs.inorgchem.7b01522

### Example 5: Synthesis of POTs with 4-Tert-Butylbenzoic Acid Ligands

Eu(Ac)₃·xH₂O (0.0192 g. 0.05 mmol) and 4-tert-butylbenzoic acid (0.044 g, 0.25 mmol) were added to 0.75 ml of tetrahydrofuran in a glass vial, Ti(OiPr)₄ (18.0 μl, 0.06 mmol) was added. The mixture was ultrasonicated for 30 minutes for complete dissolution. The clear precursor solution, hexane and carrier fluid (perfluorinated fluid) was loaded into separate 10 ml Luer Lock Syringe. Syringe pumps were used to inject the solutions into 9 m long PFA tube (kinesis 1.5 mm internal diameter) immersed in an oil bath at 80° C. The flowrate of the precursor was maintained at 0.030 ml/mins, hexane 0.120 ml/min, and 0.120 ml/min carrier fluid. The solutions met in a mixing junction (manifold Assy 7 port), the residence time in the reactor was 10 minutes. The white powder product was collected in a centrifuge tube and centrifuged at 7000 rpm for 2 min, then washed thrice with hexane and dried en vacuo. Single crystals suitable for X-ray diffraction analysis were obtained by recrystallizing the powder with THF and hexane via slow evaporation at room temperature to give colourless block crystals.

### CLAUSES

The invention may be defined according to any of the following clauses.
Clause 1. Polyoxotitanate comprising a metal oxide core and a ligand shell,
   wherein the metal oxide core comprises titanium, oxygen and a lanthanide;
   wherein the ligand shell comprises one or more light-harvesting ligands coordinated to the lanthanide;
   wherein the one or more light-harvesting ligands comprises one or more of a substituted extended aromatic ligand and a benzoate ligand.
Clause 2. Polyoxotitanate according to Clause 1, wherein the lanthanide is europium and wherein the one or more light-harvesting ligands comprises at least one selected from a benzoate ligand and a substituted phenanthroline ligand according to the following structures:

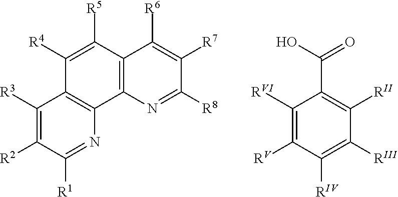

wherein R¹, R², R³, R⁴, R⁵, R⁶, R⁷ and R⁸ are independently selected from H, C₁₋₃₀ linear alkoxy, C₁₋₃₀ branched alkoxy, C₁₋₃₀ linear alkyl, C₁₋₃₀ branched alkyl, and C₁₋₃₀ fatty acids, with the proviso that at least one of R¹, R², R³, R⁴, R⁵, R⁶, R⁷ and R⁸ is not H
wherein R^{II}, R^{III}, R^{IV}, R^{V} and R^{VI} are each independently selected from H, F, isopropyl, linear or branched C₁₋₃₀ alkoxy, linear or branched C₁₋₄ alkyl and linear or branched C₅₋₃₀ alkyl.
Clause 3. Polyoxotitanate according to Clause 2, wherein R¹ and R⁸ are H and wherein R², R³, R⁴, R⁵, R⁶ and R⁷ are each independently selected from C₁₂₋₁₈ linear alkyl, C₁₂₋₁₈ branched alkyl, C₁₂₋₁₈ linear alkoxy, C₁₂₋₁₈ branched alkoxy; and
   wherein R^{II} and R^{VI} are H and wherein R^{III}, R^{IV} and R^{V} are each independently selected from C₁₂₋₁₈ linear alkyl, C₁₂₋₁₈ branched alkyl, C₁₂₋₁₈ linear alkoxy, C₁₂₋₁₈ branched alkoxy.
Clause 4. Polyoxotitanate according to Clause 1, wherein the one or more light-harvesting ligands comprises a ligand selected from 4-methoxybenzoic acid, 4-isopropylbenzoic acid, benzoic acid, and 4,7-dimethoxy-1,10-phenanthroline.
Clause 5. Polyoxotitanate according to any preceding Clause, wherein the ligand shell comprises one or more solubilizing ligands that are separate from the one or more light-harvesting ligands, optionally wherein the one or more solubilizing ligands comprises methacrylate, a fatty acid, or a carboxylic acid.
Clause 6. Polyoxotitanate according to any preceding Clause, wherein the metal in the metal oxide core is selected from Eu₈Ti₁₀ and Eu₂Ti₄.
Clause 7. Polyoxotitanates according to Clause 1 and having the formula

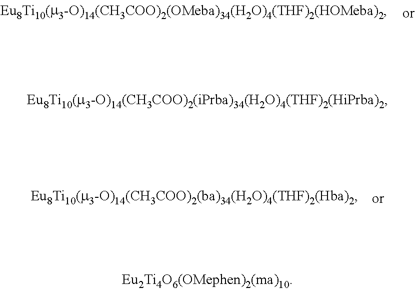

Clause 8. Method of making polyoxotitanates in a droplet flow reactor, the method comprising:
   a. providing precursors comprising a lanthanide compound, a titanium-oxygen compound and a ligand;
   b. combining the precursors and a solvent in one or more precursor flows;
   c. injecting the precursors, a carrier fluid and an antisolvent into a reaction vessel and allowing the precursors to react to form a polyoxotitanate;
   d. collecting the polyoxotitanate as it exits the reaction vessel.
Clause 9. Method according to Clause 8, wherein the reaction vessel is a tube.
Clause 10. Method according to Clause 8 or Clause 9, wherein the temperature of the reaction vessel is up to 300° C., such as from 10° C. to 90° C.
Clause 11. Method according to any of Clauses 8 to 10, further comprising:
   e. removing the carrier fluid.
Clause 12. Method according to any of Clauses 8 to 11, wherein the lanthanide compound is Eu(CH₃COO)₃.
Clause 13. Method according to any of Clauses 8 to 12, wherein the precursors comprise Ti(OiPr)₄.
Clause 14. Method according to any of Clauses 8 to 13, wherein the solvent is selected from tetrahydrofuran (THF), an alcohol and acetate.
Clause 15. Method according to any of Clauses 8 to 14, wherein the antisolvent is acetonitrile or hexane.
Clause 16. Use of a droplet flow reactor to manufacture polyoxotitanates.
Clause 17. Composite material comprising polyoxotitanates dispersed in a polymer matrix, wherein the polyoxotitanates are as defined in any of Clauses 1 to 7 or made according to the method defined in any of Clauses 8 to 15.
Clause 18. Composite material according to Clause 17, wherein the polymer matrix is one or more of polyethylene, polypropylene, polymethylmethacrylate, polycarbonate, polyether ether ketone, polyvinylacetate, ethylene-vinyl acetate, and acrylate.
Clause 19. Polytunnel sheeting comprising the composite material of Clause 17 or Clause 18.
Clause 20. Coating or paint comprising the composite material of Clause 17 or Clause 18.
Clause 21. Method for manufacturing a composite film by photopolymerization, comprising:
   a. preparing a solution of monomers, polyoxotitanates and photoinitiator;
   b. injecting the solution into a mould;
   c. curing the solution in UV light; and
   d. removing the cured composite polymer film from the mould.
Clause 22. Method for manufacturing a composite film by solution casting, comprising:
   a. preparing a solution of polymer, polyoxotitanates and solvent;
   b. pouring the solution into a mould;
   c. curing the solution by solvent evaporation;
   d. removing the cured composite polymer film from the mould.
Clause 23. Use of europium-containing polyoxotitanates in agriculture to increase the amount of red light available to plants.
Clause 24. Use of polyoxotitanates to increase the efficiency of a photovoltaic cell.
Clause 25. Use of polyoxotitanates to decrease UV damage of an encapsulated material.
Clause 26. Use according to any of Clauses 23 to 25, wherein the polyoxotitanates are as defined in any of Clauses 1 to 7 or are made according to the method of any of Clauses 8 to 15.

1. A polyoxotitanate comprising a metal oxide core and a ligand shell,
wherein the metal oxide core comprises titanium, oxygen and a lanthanide;
wherein the ligand shell comprises one or more light-harvesting ligands coordinated to the lanthanide and one or more bridging ligands;
wherein the one or more light-harvesting ligands comprises one or more of the following classes of compounds: 2-quinolines with a substituent in the 8-position; quinones; substituted 2,2′-bipyridines; substituted 1,10-phenanthrolines; naphthyridine; anthraquinones; catechols; acetylacetonates (acac); and a substituted 2,2′;6′,2″-terpyridine;
wherein a bridging ligand is bound to either two Ti atoms of the core or to Ti and a lanthanide of the core via a functional group.

2. A polyoxotitanate comprising a metal oxide core and a ligand shell,
wherein the metal oxide core comprises titanium, oxygen and a lanthanide;
wherein the ligand shell comprises one or more light-harvesting ligands coordinated to the lanthanide;
wherein the polyoxotitanate has a λₘₐₓ of up to 500 nm.

3. The polyoxotitanate of claim 1, wherein the one or more light-harvesting ligands is selected from substituted 1,10-phenanthrolines and acetylacetonates.

4. The polyoxotitanate of claim 1, wherein the light-harvesting ligand is a bidentate or tridentate chelating ligand.

5. The polyoxotitanate of claim 1, wherein the light-harvesting ligand binds to the lanthanide via N, O, or both N and O.

6. The polyoxotitanate of claim 1, wherein the lanthanide is selected from europium (Eu), samarium (Sm), erbium (Er), terbium (Tb) and ytterbium (Yb).

7. The polyoxotitanate according to claim 1 wherein a metal in the metal oxide core is selected from Eu₈Ti₁₀ and Eu₂Ti₄.

8. The polyoxotitanate of claim 1, wherein the functional group of the bridging ligand is selected from carboxylate, acetylacetonate, alcoholate, and combinations thereof.

9. The polyoxotitanate of claim 1, wherein the bridging ligand comprises one or more side chains selected from alkyl chains, poly(ethylene glycol), and combinations thereof.

10. The polyoxotitanate of claim 1, wherein the bridging ligand comprises a benzoate, an acrylate, an alkanoate, or a combination thereof.

11. The polyoxotitanate of claim 1, wherein the lanthanide is europium, the light-harvesting ligand is 4,7-dimethoxy-1,10-phenanthroline and the bridging ligand is octanoate.

12. A method of making polyoxotitanates in a droplet flow reactor, the method comprising:
a. providing precursors comprising a lanthanide compound, a titanium-oxygen compound and a ligand;
b. combining the precursors and a solvent in one or more precursor flows;
c. injecting the precursors, a carrier fluid and an antisolvent into a reaction vessel and allowing the precursors to react to form a polyoxotitanate; and
d. collecting the polyoxotitanate as it exits the reaction vessel.

13. The method according to claim 12, wherein the reaction vessel is a tube.

14. The method according to claim 12, wherein the temperature of the reaction vessel is up to 300° C.

15. The method according to claim 12, further comprising:
e. removing the carrier fluid.

16. The method according to claim 12, wherein the lanthanide compound is Eu(CH₃COO)₃.

17. The method according to claim 12, wherein the precursors comprise Ti(OiPr)₄.

18. The method according to claim 12, wherein the solvent is selected from tetrahydrofuran (THF), an alcohol and acetate.

19. The method according to claim 12, wherein the antisolvent is acetonitrile or hexane.

20. (canceled)

21. A composite material comprising polyoxotitanates dispersed in a polymer matrix, wherein the polyoxotitanates are of claim 1.

22. The composite material according to claim 21, wherein the polymer matrix is one or more of polyethylene, polypropylene, polymethylmethacrylate, polycarbonate, polyether ether ketone, polyvinylacetate, ethylene-vinyl acetate, and acrylate.

23. A polytunnel sheeting comprising the composite material of claim 21.

24. A coating or a paint comprising the composite material of claim 21.

25. A method for manufacturing a composite film by photopolymerization, comprising:
a. preparing a solution of monomers, polyoxotitanates and photoinitiator;
b. injecting the solution into a mould;
c. curing the solution in UV light; and
d. removing the cured composite polymer film from the mould.

26. A method for manufacturing a composite film by solution casting, comprising:
a. preparing a solution of polymer, polyoxotitanates and solvent;
b. pouring the solution into a mould;
c. curing the solution by solvent evaporation; and
d. removing the cured composite polymer film from the mould.

27.-30. (canceled)
